(19) United States
(12) Patent Application Publication
(10) Pub. No.: US 2006/0173668 A1
(43) Pub. Date: Aug. 3, 2006

(54) Identifying data patterns

(75) Inventors: Karen Z. Haigh, Greenfield, MN (US); Wendy Foslien Graber, Woodbury, MN (US); Valerie Guralnik, Orono, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International, Inc.

(21) Appl. No.: 11/032,588

(22) Filed: Jan. 10, 2005

(51) Int. Cl. G06F 17/50; G06G 7/62

(52) U.S. Cl. 703/17

(57) ABSTRACT

Time series data is modeled to understand typical behavior in the time series data. Data that is notably different from typical behavior, as identified by the model, is used to identify candidate patterns corresponding to events that might be interesting. The model may be revised by removing model biasing events so that it better reflects normal or typical behavior. Interesting patterns are then reidentified based on the revised model. The set of interesting patterns is iteratively pruned to result in a set of candidate features to be applied in a time series search algorithm.

### RELATED APPLICATION

This application is related to U.S. Pat. No. 6,754,388, entitled “Content-Based Retrieval of Series Data” at least for its teaching with respect to searching of time series data using data patterns, which is incorporated herein by reference.

### FIELD OF THE INVENTION

The present invention relates to time series data, and in particular to patterns in time series data.

### BACKGROUND OF THE INVENTION

In many industries, large stores of data are used to track variables over relatively long expanses of time or space. For example, several environments, such as chemical plants, refineries, and building control, use records known as process histories to archive the activity of a large number of variables over time. Process histories typically track hundreds of variables and are essentially high-dimensional time series. The data contained in process histories is useful for a variety of purposes, including, for example, process model building, optimization, control system diagnosis, and incident (abnormal event) analysis.

Large data sequences are also used in other fields to archive the activity of variables over time or space. In the medical field, valuable insights can be gained by monitoring certain biological readings, such as pulse, blood pressure, and the like. Other fields include, for example, economics, meteorology, and telemetry.

In these and other fields, events are characterized by data patterns within one or more of the variables, such as a sharp increase in temperature accompanied by a sharp increase in pressure. Thus, it is desirable to extract these data patterns from the data sequence as a whole. Data sequences have conventionally been analyzed using such techniques as database query languages. Such techniques allow a user to query a data sequence for data associated with process variables of particular interest, but fail to incorporate time-based features as query criteria adequately. Further, many data patterns are difficult to describe using conventional database query languages.

Another obstacle to efficient analysis of data sequences is their volume. Because data sequences track many variables over relatively long periods of time, they are typically both wide and deep. As a result, the size of some data sequences is on the order of gigabytes. Further, most of the recorded data tends to be irrelevant. Due to these challenges, existing techniques for extracting data patterns from data sequences are both time consuming and tedious.

Many different techniques have been used to find interesting patterns. Many require a user to identify interesting patterns. In one technique, a graphical user interface is used to find data patterns within a data sequence that match a target data pattern representing an event of interest. In this technique, a user views the data and graphically selects a pattern. A pattern recognition technique is then applied to the data sequence to find similar patterns that match search criteria. It is not only tedious to identify patterns by hand, but moreover, there may be other patterns of interest that are not easily identified by a user. Brute force methods have been discussed in the art, and involve searching a data sequence for all potential patterns, finding the probabilities for each pattern, and sorting. This method requires massive amounts of resources and is impractical to implement for any significant amount of time series data.

### SUMMARY OF THE INVENTION

Time series data is modeled to understand typical behavior in the time series data. Empirical or first principles models may be used. Data that is notably different from typical behavior, as identified by the model, is used to identify candidate patterns corresponding to events that might be interesting. These data patterns are provided to a search engine, and matches to the data patterns across the entire body of data are identified. The model may be revised by removing model biasing events so that it better reflects normal or typical behavior. Interesting patterns are then reidentified based on the revised model.

### BRIEF DESCRIPTION OF THE DRAWINGS

FIG. 1 is a block diagram of an example computer system for implementing various embodiments of the invention.

FIG. 2 is a simplified flowchart illustrating selection of candidate features according to an example embodiment.

FIG. 3 is a more detailed flowchart illustrating selection of candidate features according to an example embodiment of FIG. 2.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

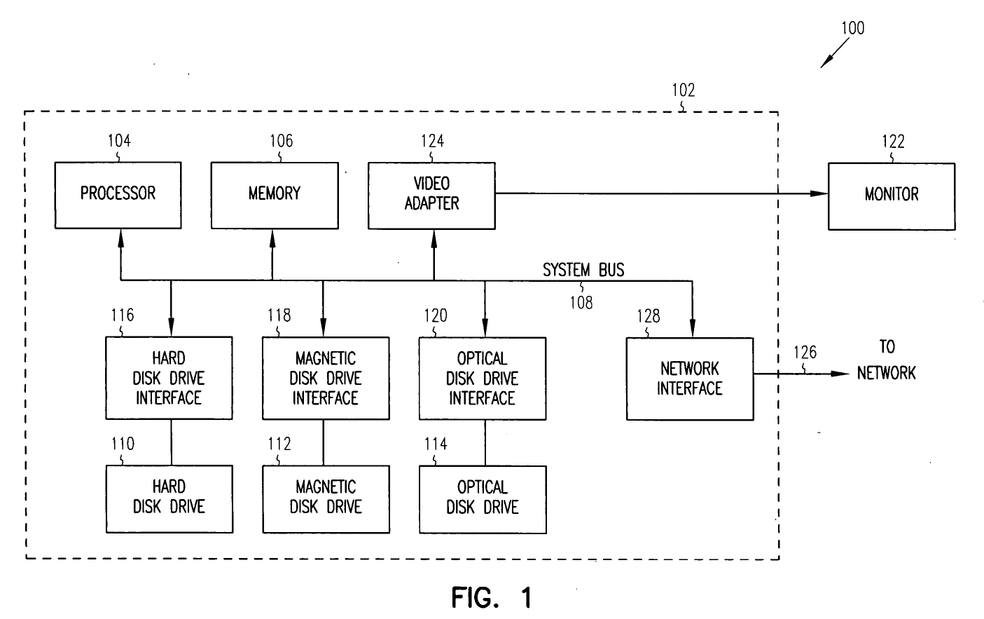

FIG. 1 depicts an example computer arrangement 100 for analyzing a data sequence. This computer arrangement 100 includes a general purpose computing device, such as a computer 102. The computer 102 includes a processing unit 104, a memory 106, and a system bus 108 that operatively couples the various system components to the processing unit 104. One or more processing units 104 operate as either a single central processing unit (CPU) or a parallel processing environment.

The computer arrangement 100 further includes one or more data storage devices for storing and reading program and other data. Examples of such data storage devices include a hard disk drive 110 for reading from and writing to a hard disk (not shown), a magnetic disk drive 112 for reading from or writing to a removable magnetic disk (not shown), and an optical disc drive 114 for reading from or writing to a removable optical disc (not shown), such as a CD-ROM or other optical medium.

The hard disk drive 110, magnetic disk drive 112, and optical disc drive 114 are connected to the system bus 108 by a hard disk drive interface 116, a magnetic disk drive interface 118, and an optical disc drive interface 120, respectively. These drives and their associated computer-readable media provide nonvolatile storage of computer-readable instructions, data structures, program modules, and other data for use by the computer arrangement 100. Any type of computer-readable media that can store data that is accessible by a computer, such as magnetic cassettes, flash memory cards, digital versatile discs (DVDs), Bernoulli cartridges, random access memories (RAMs), and read only memories (ROMs) can be used in connection with the present invention.

A number of program modules can be stored or encoded in a machine readable medium such as the hard disk, magnetic disk, optical disc, ROM, RAM, or an electrical signal such as an electronic data stream received through a communications channel. These program modules include an operating system, one or more application programs, other program modules, and program data.

A monitor 122 is connected to the system bus 108 through an adapter 124 or other interface. Additionally, the computer arrangement 100 can include other peripheral output devices (not shown), such as speakers and printers.

The computer arrangement 100 can operate in a networked environment using logical connections to one or more remote computers (not shown). These logical connections are implemented using a communication device coupled to or integral with the computer arrangement 100. The data sequence to be analyzed can reside on a remote computer in the networked environment. The remote computer can be another computer, a server, a router, a network PC, a client, or a peer device or other common network node. FIG. 1 depicts the logical connection as a network connection 126 interfacing with the computer arrangement 100 through a network interface 128. Such networking environments are commonplace in office networks, enterprise-wide computer networks, intranets, and the Internet, which are all types of networks. It will be appreciated by those skilled in the art that the network connections shown are provided by way of example and that other means of and communications devices for establishing a communications link between the computers can be used.

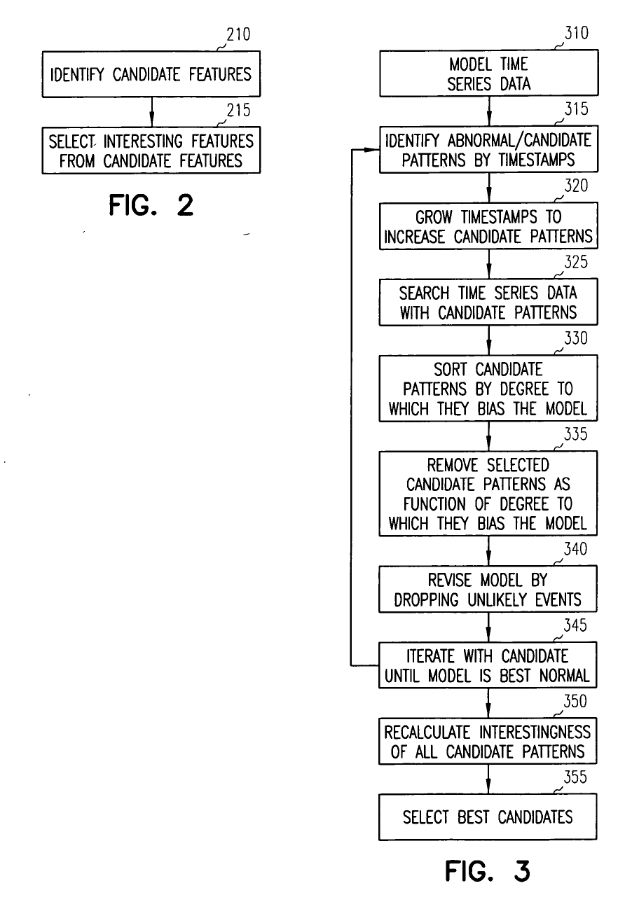

FIG. 2 is a high level flow chart of one embodiment of the invention used to find unexpected patterns in time series data. Such unexpected patterns may be used as candidates for a search algorithm to identify where such patterns appear in further time series data. At 210, candidate features are identified by one of several methods. A model of the time series data may be created, and values of the time series data that are notably different from typical are used to identify candidate patterns.

In one embodiment, to understand the characteristics of the data, the models may include empirical or first principles models. First principles models are typically physical models based on real-world phenomena, such as physics and chemistry. Empirical models are built from observed data, and may capture statistical, logical, symbolic and other relationships. For example, a simple statistical model includes mean and variance; Candidate patterns may be identified on the basis of deviation from the mean. Another model might include a distribution of the data that could be used to understand sharp transitions or unusual values, and identify candidate patterns. A third model, based on Principal Component Analysis over a true set of normal data, might yield a Q statistic which measures the deviation of the new time series observation from the normal data in a multivariate sense. If Q statistic goes high, then the data is not normal. Top contributor variables to the high Q stat may then be used to identify candidate patterns. A fourth model might include regression techniques that identify candidate patterns corresponding to high residuals.

One further model of the time series data comprises an operator log. When an operator of a process makes note of unusual behavior, or changes setpoints, the time series data, or data patterns will often change. These noted events may be used to identify candidate patterns.

In each of these cases, we select a candidate pattern over a range of time stamps. The candidate pattern is a sequence of observations in the time series data. To expand the set of candidate patterns, the range of time stamps may be expanded on either side of the core set of time stamps, and multiple further patterns identified. For example, data corresponding to the unusual behavior may be referred to as a “seed pattern”. Timestamps for the start and end of this seed pattern are extracted. Additional patterns to the candidate patterns are added by expanding a time range represented by the start and end time stamps. For example, one additional candidate pattern may range from several timestamps prior to the start of the seed pattern to the end of the seed pattern. Similarly, another candidate pattern may start from the beginning of the seed pattern to several timestamps past its end. Several additional patterns may be added by varying the range of timestamps

At 215, interesting features are selected from the candidate features or patterns. Interesting features may be identified as those features which are outside the range of normal or typical behavior represented by the model of the time series data. In one embodiment, the candidate pattern set may be run through a search engine to determine the probabilities of occurrence for each pattern in the time series data. Many different search engines may be used, such as those described in U.S. Pat. No. 6,754,388, entitled “Content-Based Retrieval of Series Data” at least for its teaching with respect to searching of time series data using data patterns, which is incorporated herein by reference. In one embodiment, the search engine comprises an application written in Visual C++, and uses Microsoft, Inc. Foundation Classes along with several Component Object Model (COM) entities. The default search algorithm uses an implementation of a simple moving window correlation calculation; other search algorithms may be added by designing additional COM libraries. The application also allows the selection of patterns viewed using a graphical user interface.

The resulting candidate patterns are sorted by probability in one embodiment. Those occurring with highest frequency may not be very interesting, since they represent common events. If a pattern happens only once, it may or may not be interesting. It may be interesting because it relates to an event that happened just once, such as fire or explosion. Patterns that represent noise, or are based on very wide ranges of time stamps may also not be interesting. Long time range patterns are less likely to happen again. This may be so because there are fewer chances to find a long time range pattern as compared to a pattern having a shorter time range in a given set of time series data.

The model may be revised by removing selected events that bias the model away from typical or normal behavior. In one embodiment, selected events are dropped out of the time series data on which the original model is calculated; if a newly calculated model differs significantly from the original, then the event biased the original model away from normal, and is referred to as an unlikely event (and hence should not be considered part of a model of normal behavior). If the selected event were noise, the original model would have caught it and the new model would be relatively unchanged The new model based on data with the unlikely event or events removed should more accurately represent normal behavior.

Different embodiments may use different mechanisms for determining whether an event or pattern is unlikely. One embodiment may use a function of a confidence interval, such as exceeding a standard deviation by a threshold. Another embodiment may use parametric shifts in the model if an event is dropped, such as a shift in the mean of the data. Other statistical distances may also be used. In one embodiment using a symbolic model, a pattern may be found unlikely as a function of a root test on a decision tree.

Unlikely events may be dropped out individually in an iterative manner, iteratively recalculating probabilities of candidate patterns against each updated model. Unlikely events may also be dropped out in subsets of two or more, again iteratively revising the model, or incrementally improving the model, and recalculating probabilities of candidate patterns. In one embodiment, the unlikely events are arranged in order of most likely effect on the model, and when the model does not change much between drop outs, a final model is selected as the best. All the candidate patterns may then be run against the final model, and their probabilities calculated. The recalculation of candidate patterns against the revised model may change which events are characterized as interesting.

FIG. 3 is a flowchart showing a detailed process for selecting interesting patterns. Time series data is modeled at 310. In one embodiment, the model is a statistical model that is formed using a block of data as a training set. Timestamps corresponding to candidate patterns are identified at 315. At 320, the time stamps may be grown or modified to increase the set of candidate patterns. At 325, the time series data is searched using the candidate patterns and a set of matches to the candidate patterns is identified, and at 330, the candidate patterns are sorted by the degree to which they bias the model, using the candidate patterns and their associated set of matches. In one embodiment, they may be sorted as a function of probability of occurrence. In other words, the number of times that they appear in the time series data.

At 335, unlikely events or candidate patterns may be removed from the training set as a function of the degree to which they bias the model. At 340, unlikely events are dropped from the training set, and the model is recalculated or retrained with the modified data set. The revised model is less biased due to such events being dropped, and is thus a better model of normal behavior. At 345, an iteration back to 315 is performed, such that the model is continuously modified by dropping more unlikely events from the training set of data.

Once the model is best representative of normal behavior of the process being monitored as represented by the time series data, a degree of interestingness for each of the candidate patterns is recalculated at 350, and the most interesting candidate patterns are selected at 355. These patterns may be added to a library that can then be examined by a human user, or run against new time series data to continuously monitor processes for abnormal or interesting behavior.

In some embodiments, correlations across related time series data are performed. Since some processes may have more than one sensor monitoring a process variable, such as a temperature, it is likely that interesting events may be occurring at the same time in time series data for the different sensors. This can be used as an indication that a pattern is interesting. It can also be useful to know that a related sensor is not detecting abnormal behavior, while related sensors are. Such information may be used to help identify causes of abnormal behavior or faulty sensors. Still further, temporal relationships between time series data of different sensors may represent a propagating event. In other words, an event may take time to propagate downstream in a process, only being reflected by time series data of other sensors later in time. Thus, a pattern may be interesting when accompanied by a selected pattern from a related sensor, either at the same time, or separated in time.

1. A computer implemented method comprising:
characterizing behavior of time series data; and
evaluating the time series data against the characterized behavior to identify candidate patterns in the time series data.

2. The method of claim 1 and further comprising screening the candidate patterns to identify interesting patterns.

3. The method of claim 2 wherein the characterized behavior is representative of normal behavior of the time series data, and interesting patterns are outside of such normal behavior.

4. The method of claim 1 wherein characterizing behavior comprises forming a model of normal behavior of the time series data.

5. The method of claim 4 and further comprising revising the model of normal behavior.

6. The method of claim 5 wherein revising the model of normal behavior comprises:
identifying candidate patterns that bias the model;
removing such identified candidate patterns; and
calculating the model of normal behavior with such identified candidate patterns removed.

7. The method of claim 1 wherein characterizing behavior comprises retrieving a model of normal behavior of the time series data.

8. A computer implemented method comprising:
generating a model of normal behavior of time series data;
evaluating the time series data against the model to identify a set of candidate patterns in the time series data;
removing uninteresting candidate patterns from the set of candidate patterns;
revising the model by removing unlikely patterns from the time series data; and
determining interesting patterns from the set of candidate patterns using the revised model.

9. The method of claim 8 wherein the interesting patterns are added to a database of patterns.

10. A method comprising:
modeling time series data;
identifying candidate patterns as a function of deviations from the model;
revising the model by removing unlikely events in the time series data; and
comparing the candidate patterns to the revised model of the time series data to identify interesting patterns.

11. The method of claim 10 wherein the time series data is modeled with a statistical model.

12. The method of claim 11 wherein the model comprises mean and variance of values in the time series data.

13. The method of claim 11 wherein the time series data is modeled by principal component analysis, and a Q statistic is used to identify candidate patterns.

14. The method of claim 10 wherein the time series data is modeled using a non statistical method.

15. The method of claim 14 wherein the non statistical method is selected from the group consisting of hand labelling methods and symbolic machine learning methods.

16. The method of claim 15 wherein the hand labeling methods include operator logs.

17. The method of claim 15 wherein the symbolic machine learning methods include decision trees and genetic algorithms.

18. The method of claim 10 wherein a candidate pattern is identified by a core range of timestamps corresponding to the time series data.

19. The method of claim 18 wherein additional candidate patterns are identified by varying the range of timestamps about the core range of timestamps.

20. The method of claim 10 and further comprising determining a probability of occurrence for each candidate pattern.

21. The method of claim 20 wherein high probability patterns are removed from the candidate patterns.

22. The method of claim 20 wherein long patterns are removed from the candidate patterns.

23. The method of claim 10 wherein unlikely events are removed from the model independently.

24. The method of claim 10 wherein unlikely events are removed from the model in subsets.

25. The method of claim 10 wherein interesting patterns are identified as a function of related time series data.

26. A computer readable medium having instruction for causing a computer to implement a method comprising:
modeling time series data;
identifying candidate patterns as a function of deviations in the model;
revising the model by removing unlikely events in the time series data; and comparing the candidate patterns to the revised model of the time series data to identify interesting patterns.

27. The computer readable medium of claim 26 wherein the time series data is modeled with a statistical model.

28. The computer readable medium 26 wherein the model comprises mean and variance of values in the time series data.

29. The computer readable medium of claim 26 wherein a candidate pattern is identified by a fixed set of timestamps corresponding to the time series data.

30. The computer readable medium of claim 27 wherein additional candidate patterns are identified by varying the fixed set of timestamps about the fixed set of timestamps.

31. The computer readable medium of claim 27 and further comprising determining a probability of occurrence for each candidate pattern.

32. The computer readable medium claim 31 wherein high probability patterns are removed from the candidate patterns.

33. The computer readable medium of claim 31 wherein long patterns are removed from the candidate patterns.

34. A system comprising:
a modeler that models time series data;
an identifier that identifies candidate patterns as a function of deviations in the model;
means for revising the model by removing unlikely events in the time series data; and
a comparator that compares the candidate patterns to the revised model of the time series data to identify interesting patterns.
